(19) United States
(12) Patent Application Publication
(10) Pub. No.: US 2012/0066619 A1
(43) Pub. Date: Mar. 15, 2012

(54) APPARATUS AND METHOD FOR INFORMATION TRANSMISSION BETWEEN TV AND MOBILE COMMUNICATION SYSTEM

(75) Inventor: Sang-Yong LEE, Seoul (KR)

(73) Assignee: SAMSUNG ELECTRONICS CO., LTD., Gyeonggi-Do (KR)

(21) Appl. No.: 13/228,929

(22) Filed: Sep. 9, 2011

(30) Foreign Application Priority Data
Sep. 15, 2010 (KR) 10-2010-0090460

(51) Int. Cl. G06F 3/01; G06F 15/16

(52) U.S. Cl. 715/760

(57) ABSTRACT

An apparatus and a method for transmitting an Internet site address are provided. In the method of a mobile communication terminal, for information transmission between a television (TV) and the mobile communication terminal, whether input of a specific button or gesture is detected during web surfing is determined. When the input of the specific button is detected, an address of an Internet site currently under web surfing is stored. The stored address of the Internet site is transmitted to the TV for display. Control of the web browser can be transferred to the TV or retained by the mobile communication terminal. The Internet site displayed by the TV can also be sent to the mobile communication terminal to the TV.

### CLAIM OF PRIORITY

This application claims the benefit of priority under 35 U.S.C. §119(a) of a Korean patent application filed in the Korean Intellectual Property Office on Sep. 15, 2010 and assigned Serial No. 10-2010-0090460, the entire disclosure of which is hereby incorporated by reference in its entirety.

### BACKGROUND OF THE INVENTION

1. Field of the Invention

The present invention relates to information transmission between an Internet television (TV) and a mobile communication terminal. More particularly, the present invention relates to an apparatus and a method for transmitting a Uniform Resource Locator (URL) between an Internet TV and a mobile communication terminal.

2. Description of the Related Art

As the Internet is usable anytime and anywhere, a TV that can communicate via the Internet to allow a user to Internet access when the TV is being used. In addition, a mobile communication terminal that can use the Internet is widely used.

However, in the case where a user desires to switch to from a first device that uses the Internet to a second device while still using the Internet, for example, switching via a mobile communication terminal or TV using the Internet, an apparatus and a method for such switching is unknown heretofore.

Therefore, there is a need in the art for an apparatus and a method that allows a user to continuously access the Internet by allowing the user to change a from one device that uses the Internet to a different device while accessing the Internet using a specific device.

### SUMMARY OF THE INVENTION

The present invention addresses at least in part some of the above-mentioned problems and/or disadvantages and provides at least the advantages described below. Accordingly, an exemplary aspect of the present invention provides an apparatus and a method for information transmission between an Internet TV and a mobile communication system.

An exemplary aspect of the present invention is to provide an apparatus and a method for allowing the user to continuously access the Internet via the TV by transmitting an Internet Uniform Resource Locator (URL) of the mobile communication terminal in use to a web browser of the TV, when a user desires to access the Internet via a TV while currently accessing the Internet via a mobile communication terminal.

In accordance with another exemplary aspect of the present invention, a method of a mobile communication terminal for information transmission between a television (TV) and the mobile communication terminal is provided. The method includes determining whether or not input of a specific button (or gesture, including but not limited to multiple touch gestures or other hand movements is detected during web surfing, when detecting the input of the specific button, storing an address of an Internet site currently being accessed under web surfing, and transmitting the stored address of the Internet site to the TV. It should also be understood and appreciated that instead of buttons or gestures, moving the mobile communication terminal to a certain orientation or in a certain way can constitute a gesture.

In accordance with another exemplary aspect of the present invention, a method of a television (TV), for information transmission between the TV and a mobile communication terminal is provided. The method includes determining whether or not an address of an Internet site is received from the mobile communication terminal, accessing the received address of the Internet site, determining whether input of a specific button is detected when receiving the address of the Internet site from the mobile communication terminal, storing an address of an Internet site currently under web surfing when detecting the input of the specific button, and transmitting the stored address of the Internet site to the mobile communication terminal.

In accordance with still another exemplary aspect of the present invention, an apparatus of a mobile communication terminal for information transmission between a television (TV) and a mobile communication terminal is provided. The apparatus preferably includes a first modem for communicating with a base station, a second modem for communicating with the TV, and a controller for determining whether an input of a specific button is detected during web surfing via the first modem, when detecting the input of the specific button, storing an address of an Internet site currently under web surfing, and transmitting the stored address of the Internet site to the TV via the second modem.

In accordance with a further exemplary aspect of the present invention, an apparatus of a television (TV), for information transmission between the TV and a mobile communication terminal is provided. The apparatus includes a modem for communicating with the mobile communication terminal, and a controller for determining whether an address of an Internet site is received from the mobile communication terminal via the modem, when receiving the address of the Internet site from the mobile communication terminal, accessing the address of the Internet site received via the modem, determining whether or not input of a specific button is detected, and when detecting the input of the specific button, storing an address of an Internet site currently under web surfing, and transmitting the stored address of the Internet site to the mobile communication terminal via the modem.

Other exemplary aspects, advantages and salient features of the present invention will become more apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of certain exemplary embodiments of the present invention will be more apparent to a person of ordinary skill in the art from the following description taken in conjunction with the accompanying drawings in which:

FIG. 1 is a view illustrating a process for accessing a desired URL using an HTTP GET METHOD according to an exemplary embodiment of the present invention;

FIG. 2 is an exemplary illustration of continuously accessing a web browser of a TV while accessing a stock site using a mobile communication terminal according to an exemplary embodiment of the present invention;

FIG. 3 is an exemplary illustration of continuously accessing a web browser of a mobile communication terminal while accessing a Google™ site using a TV according to an exemplary embodiment of the present invention;

FIG. 4 is a flowchart illustrating an exemplary process for continuously accessing a web browser of a TV while accessing an Internet site using a mobile communication terminal according to an exemplary embodiment of the present invention;

FIG. 5 is a flowchart illustrating an exemplary process for continuously accessing a web browser of a mobile communication terminal while accessing an Internet site using a TV according to another exemplary embodiment of the present invention;

FIG. 6 is a block diagram illustrating an example of a mobile communication terminal according to an exemplary embodiment of the present invention; and

FIG. 7 is a block diagram illustrating a TV according to an exemplary embodiment of the present invention.

Throughout the drawings, like reference numerals will be understood to refer to like parts, components and structures.

### DETAILED DESCRIPTION

The following description with reference to the accompanying drawings is provided to assist a person of ordinary skill in the art in a comprehensive understanding of exemplary embodiments of the present invention as defined by the claims and their equivalents. The description includes various specific details to assist an artisan in that understanding but these are to be regarded as merely exemplary. Accordingly, those of ordinary skill in the art will recognize that various changes and modifications of the exemplary embodiments described herein can be made without departing from the scope and spirit of the present invention. Also, descriptions of well-known functions and constructions may be omitted for clarity and conciseness so as not to obscure the artisan's appreciation and understanding of the present invention with description of such well-known functions and constructions.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention, which is defined by the appended claims and their equivalents.

It is to be understood that the singular forms “a,” “an,” and “the” include in their scope plural references of such items unless the context clearly dictates otherwise. Thus, for example, reference to “a component surface” includes a reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

In addition, the term “TV” may also comprise any type of display with wireless communication capabilities, including but not limited to tablet computers, notebook pc's, web books, monitors. etc. Exemplary embodiments of the present invention discussed herein provide detail regarding an apparatus and a method for information transmission between an Internet TV and a mobile communication system.

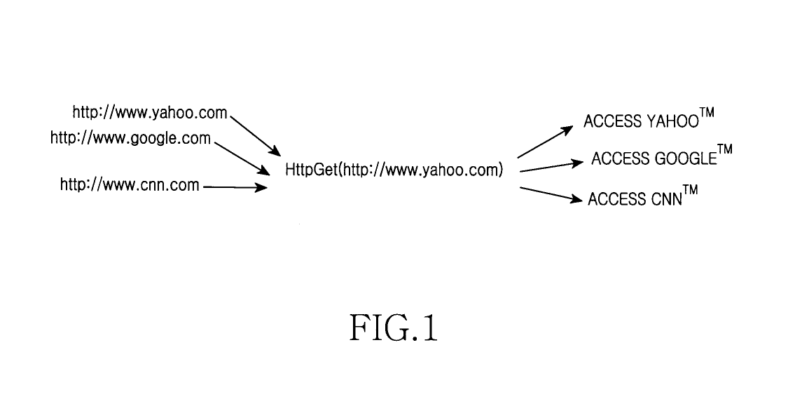

FIG. 1 is a view illustrating a process for accessing a desired URL using an HTTP GET METHOD according to an exemplary embodiment of the present invention.

Referring now to FIG. 1, a method for accessing a specific Internet page in a web browser uses “HTTP GET METHOD”. The HTTP GET METHOD retrieves information that may be in the form identified by the Request-URI. If the Request-URI refers to a data-producing process, then it is the produced data which shall be returned as the entity in the response rather than the source text of the process, an exception being, for example, when that text is the output of the process. A web browser that operates in a mobile communication terminal extracts an URL to access from a bookmark (favorite) or an URL input window to access a desired Internet page using it as a factor of HTTP GET METHOD.

The HTTP GET METHOD is used when a device including the mobile communication terminal requests a URL to a web server or the HTTP GET METHOD is used to send data to the web server.

When a user desires to continuously use the Internet while using a web browser of a large TV screen while also accessing a specific Internet page using a web browser of a mobile communication terminal, the user may transmit only the URL to the web browser of the TV to operate the web browser of the TV. In case of some portal sites, while a user performs Internet browsing, the symbols that comprise the URL may be complicated.

For example, consider a case where an URL such as “http://www.google.com/m/search?q=%EC%9B%94%EB%93%9C%EC%BB%B5&aq=2&oq=%25EC%259B%2594&aqi=g5-k6d0t0&fkt=49&fsdt=9751&cs11=&action=&ltoken=48acfb46” exists.

When a user transmits only the URL to the web browser of the TV in the web browser of the mobile communication terminal, the user may continuously use the Internet using the web browser of the TV while accessing the Internet site in the mobile communication terminal. In this exemplary aspect, the URL shown above is quite different from the conventional bookmark (favorite) of the general browser.

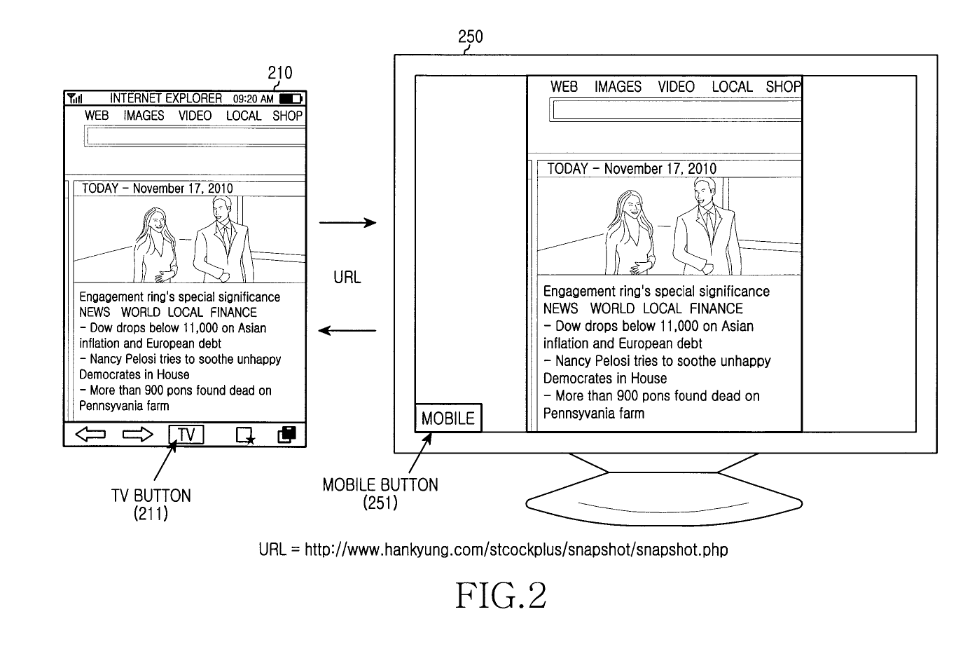

FIG. 2 is a view illustrating a case of continuously accessing a web browser of a TV while accessing a stock site using a mobile communication terminal according to an exemplary embodiment of the present invention.

Referring now to FIG. 2, in the case where a user accesses a stock site using a mobile communication terminal 210, it is difficult for the user to view and thus obtain information of a stock site having lots of graphs and tables via a typically small screen of the mobile communication terminal at a glance.

In this case, when the user transmits an URL currently in use to a web browser of a TV 250 using a ‘TV’ button 211 realized on a mobile communication terminal 210, the user may continuously access a page of the current web browser on the screen of the mobile communication terminal 210 via the web browser of the TV, and now see the information in a larger and easier to digest display than by trying to view the information on the mobile communication terminal. In addition, a reverse function, using a Mobile button 251 of the TV 250 may be possible, when a user needs to leave an area where a TV is located, but wants to continue to view what was being viewed on the TV by the display of the mobile communication terminal continuously and without having to try to recreate the steps to obtain the specific screen shown on the TV.

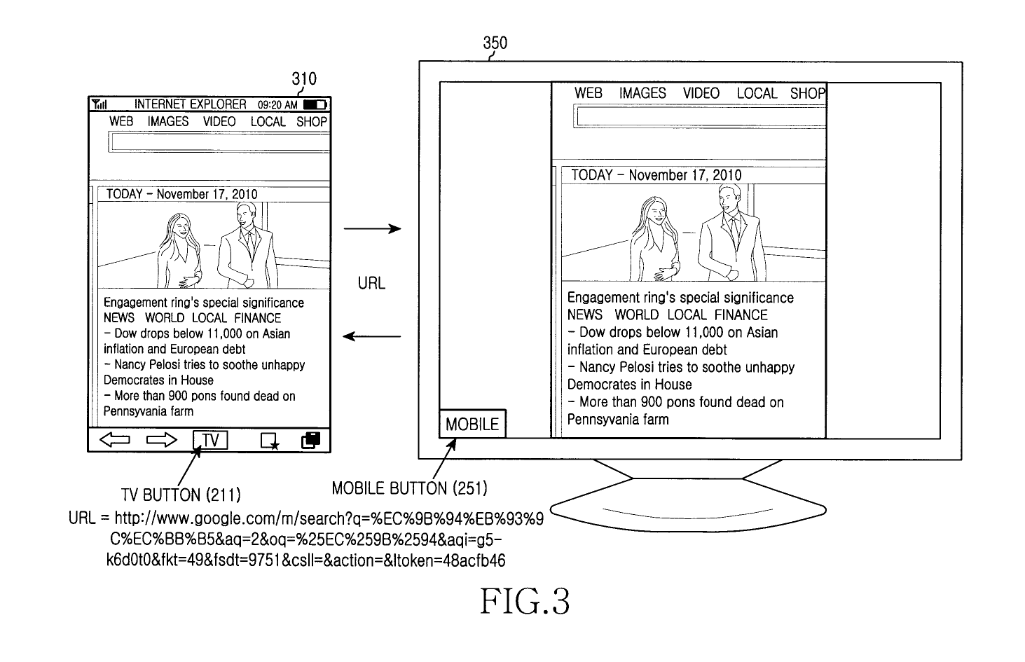

FIG. 3 is a view illustrating a case of continuously accessing a web browser of a mobile communication terminal while accessing a Google™ site using a TV according to an exemplary embodiment of the present invention.

Referring now to FIG. 3, in the case where a user has to continuously use the Internet via the mobile communication terminal 310 while using the Internet via a TV 350 due to go out or other reasons, the user may press a Mobile button 251 of the TV 350 (located on a touch panel of the TV 350 or on a remote controller) to transmit a currently accessed URL to the mobile communication terminal 310.

After that, a web browser is operated and displayed in the mobile communication terminal 310 with the same page viewed on the TV, so that the user may continuously view contents that have been viewed via the TV 350 via the mobile communication terminal 310.

According to an exemplary embodiment of the present invention, even when an URL is considerably complicated while a user links to a page in case of some Internet site, the user does not need to directly input the URL (such as by typing, or copying and pasting) on a web browser of the TV but may conveniently access the relevant page via the TV using the URL used in the mobile communication terminal by the mere touch of the TV button 211.

Conventionally, a ‘TV-OUT’ function is a connection realized in some mobile communication terminal for connecting the mobile communication terminal with a TV using a wired line, typically plugging in a jack. In contrast, a method proposed by an exemplary embodiment of the present invention extracts only a currently connected URL and transmits the same to a web browser of the TV via wireless communication (short distance communication: for example, Bluetooth or Infrared communication, etc., and not limited to a specific protocol). Thus, there is no need for physical connection between the mobile communication terminal and the TV.

At this point, a device which the user is viewing changes from the mobile communication terminal to the TV. That is, a control right is turned over to the web browser of the TV, so that the power of the mobile communication terminal is no longer being consumed.

One of the differences between a general bookmark and a URL is that the bookmark allows a device to move to a designated site always, but an exemplary embodiment of the present invention allows the web browser of the TV to immediately receive contents accessed by the web browser of the mobile communication terminal and a user may continuously use the Internet via a large screen.

The TV 250, 350 shown in the exemplary embodiments of the present invention has a wireless unit that transmits a short distance wireless Internet. Though the kind of a short distance wireless communication unit of the present invention is not limited, the Bluetooth is taken as one possible example for transmission.

In this case, a plurality of TVs may exist, and a procedure where a user selects a TV to connect and performs paring with a mobile communication terminal may be required.

In other words, the TV of the present invention mounts a Bluetooth module for cooperation with other devices. Even when the power of the TV is turned off, as far as an external power source of the TV is not shut down completely, when the TV Bluetooth module is turned on, in the case where the power of the TV is not shut down completely and simply turned off, the TV may perform Bluetooth transmission/reception.

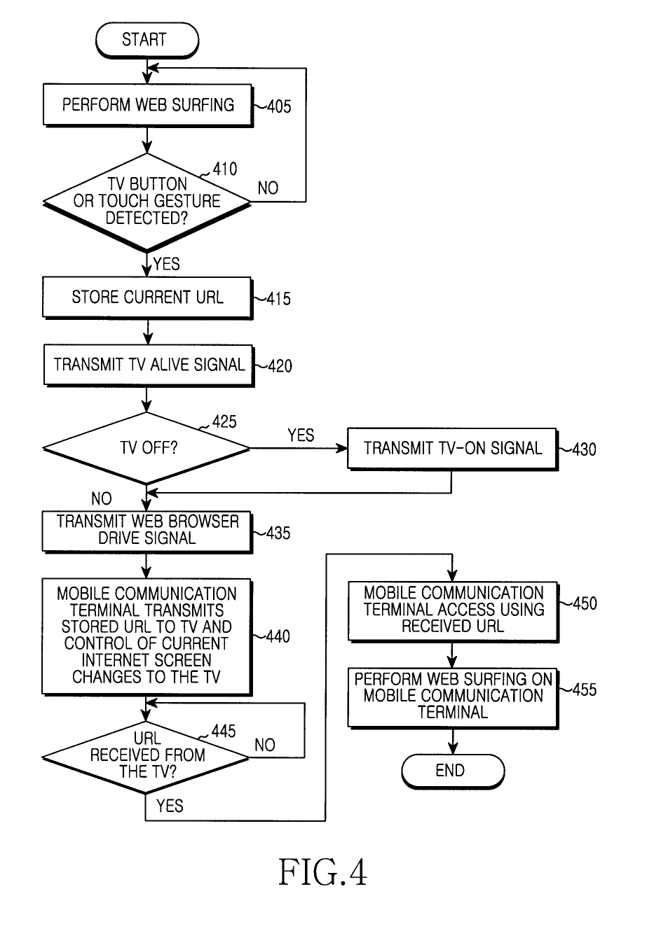

FIG. 4 is a flowchart illustrating an exemplary process for continuously accessing a web browser of a TV while accessing an Internet site using a mobile communication terminal according to an exemplary embodiment of the present invention.

Referring now to FIG. 4, at (405) a user is performing web surfing using a mobile communication terminal when the mobile communication terminal detects input of a TV button (410) or touch gesture on the TV button (410) while the user is performing the web surfing, At (415), in response to the detection of the TV button being actuated, the mobile communication terminal stores a current URL. At (420), the mobile communication terminal transmits a TV ALIVE signal to the TV in order to detect whether the TV is turned on/off. As described above, the short distance wireless communication unit for transmitting a TV ALIVE signal and a URL used in an exemplary embodiment of the present invention may use virtually any short distance protocol, including but in no way limited to Bluetooth. The TV ALIVE signal is a message requesting the on/off status of the TV.

Here, since the Bluetooth wireless communication unit (for example, a modem) of the TV is always turned on, it may respond to the TV ALIVE signal. That is, the power of the TV may not be completely shut down, and the TV may respond to the TV ALIVE signal even though the TV is not sufficiently powered on to be 100% operational. There is a difference between “turned off” and “powered off”.

In addition, the mobile communication terminal receives a response to the TV ALIVE signal to determine whether the TV is turned on/off.

At (425), wherein the mobile communication determines that the TV is turned off, then at (430) the mobile communication terminal transmits a TV-on signal to the TV.

With continued reference to FIG. 4, at (435) the mobile communication terminal transmits a web browser drive signal to the TV and then at (440) transmits a stored URL to the TV. Thus, the stored URL is transferred to the TV and the user can performs web surfing using the TV.

After (440) of the operation, a primary web browser controlling a current Internet screen changes from the web browser of the mobile communication terminal to the web browser of the TV. That is, a change of a control right occurs. The change of control right can occur after a confirmation that the URL was successfully received, but such confirmation is optional. The Internet site corresponding the URL may be displayed by both the mobile communication terminal and the TV.

Hereafter, when the user determines that the web surfing using the mobile station is needed and when the TV detects input of a TV button or touch gesture on the TV button, in response to the detection of the TV button being actuated, the TV stores a current URL and transmits a stored URL to the mobile communication terminal. At this time, the TV may transmit a web browser drive signal to the mobile communication terminal before transmitting the stored URL.

At (445) if the mobile communication terminal receives a URL from the TV, then at (450) the mobile communication terminal drives the web browser and accesses the URL. In other words, a change of the control right has occurred a second time from the TV back to the mobile communication terminal.

At (455) the performing additional web surfing using the mobile communication terminal. The Internet site corresponding the URL may be displayed by both the mobile communication terminal and the TV.

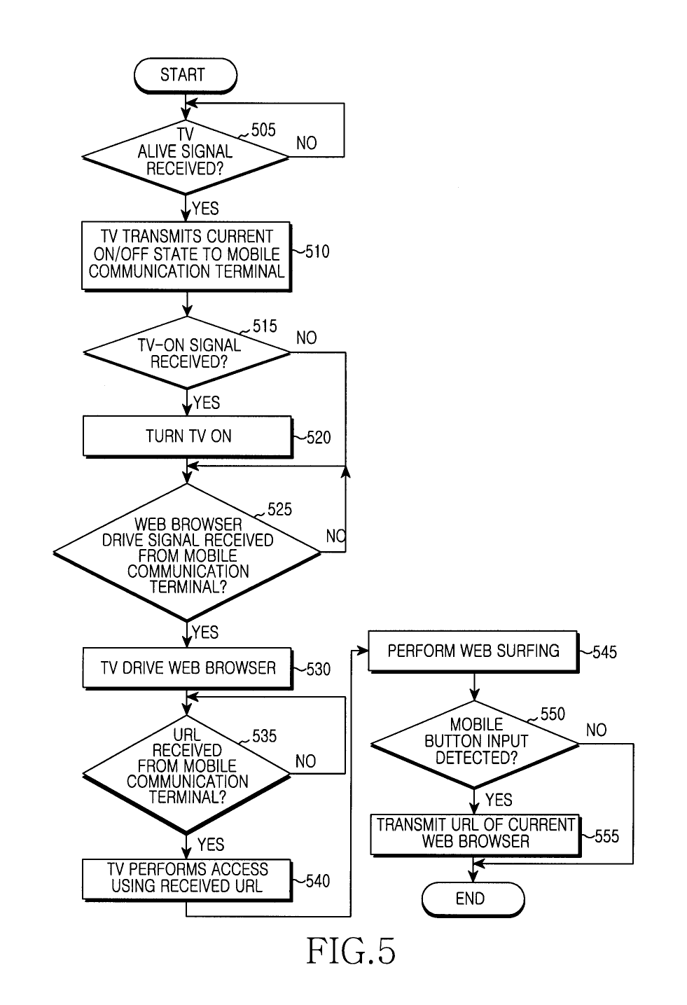

FIG. 5 is a flowchart illustrating an exemplary process for continuously accessing a web browser of a mobile communication terminal while accessing an Internet site using a TV according to an exemplary embodiment of the present invention.

Referring now to FIG. 5, at (505) when the TV 250, 350 receives a TV ALIVE signal from the mobile communication terminal, then at (510) the TV 250, 350 transmits a current on/off state to the mobile communication terminal.

At (515), when receiving a TV-on signal, then at (520) TV is turned on.

At (525) when receiving a web browser drive signal from the mobile communication terminal, then at (530) TV drives a web browser.

At 535, when receiving a URL from the mobile communication terminal, then at (540) the TV performs an Internet access using the received URL. At (545) optional additional web surfing may optionally be performed.

The Internet site corresponding the URL may be displayed by both the mobile communication terminal and the TV.

At (550), when detecting input of a Mobile button by the user, then at (555) the TV transmits a current URL of the web browser to the mobile communication terminal. The Internet site corresponding the URL may be displayed by both the mobile communication terminal and the TV.

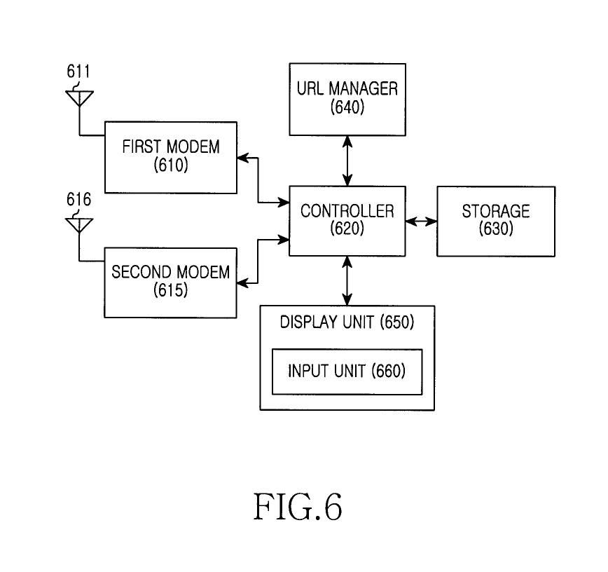

FIG. 6 is a block diagram illustrating a mobile communication terminal according to an exemplary embodiment of the present invention.

Referring now to FIG. 6, the mobile communication terminal preferably includes a first modem (610), a second modem (615), a controller 620, a storage 630, an URL manager 640, a display unit 650, and an input unit 660.

The first modem (610) and the second modem (615) are modems for communicating with other devices, and each of them includes at least a Radio Frequency (RF) processor and a baseband processor (both not shown). The RF processor changes a signal received via an antenna into a baseband signal to provide the same to the baseband processor, and changes a baseband signal from the baseband processor to an RF signal so that it may be transmitted on an RF path to transmit the same via the antenna 611, 616.

In addition, a wireless access technology of the first modem 610 is not limited to a particular frequency or protocol. In other words, the present invention can utilize a wireless access technology such as 3G, 2G, 4G, WIMAX, and WLAN, just to name a few possibilities, and may be selectively used when needed.

Likewise, a wireless access technology of the second modem (615) is not limited to a particular frequency of protocol. However, the second modem (615) preferably is used for short distance wireless communication and will transmit via Bluetooth, for example, according to an exemplary embodiment of the present invention.

With continued reference to FIG. 6, the controller 620, which may comprise a processor or microprocessor that executes machine readable code, controls an overall operation of the mobile communication terminal. For example, the controller 620 may perform processes and controls for voice communication and packet communication. More particularly, according to an exemplary embodiment of the present invention, the controller 620 preferably controls the URL manager 640.

The storage 630, which is a non-transitory machine readable medium, stores programs for controlling an overall operation of the mobile communication terminal and temporary data occurring during execution of programs.

The display unit 650 displays data output on a screen by the controller 620. In addition, the input unit 660 provides data input by a user to the controller 620. The input unit 660 is preferably located on the display unit 650 and may be a transparent touch panel with a virtual keyboard. In addition, the input unit 660 includes the above-described TV button. It is possible the input unit is a separate unit such a keyboard, in addition to the display or to complement the touch panel and the display for certain input, or user preference.

When the URL manager 640 detects input of the TV button while the user is performing web surfing using the mobile communication terminal, the URL manager 640 stores a current URL in the storage 630.

After that, the URL manager 640 transmits a TV ALIVE signal to the TV via the second modem (615) in order to detect whether or not the TV is turned on/off.

Here, since the Bluetooth wireless communication unit (for example, a modem) of the TV is always turned on, it can respond to the TV ALIVE signal. That is, when the power of the TV is not completely shut down, the TV can respond to the TV ALIVE signal.

The TV ALIVE signal may be a signal representing an on or off status. In addition, the mobile communication terminal may receive a response to the TV ALIVE signal to determine whether the TV is turned on/off.

When the TV is turned off, the URL manager 640 transmits a TV-on signal to the TV via the second modem (615). After that, the URL manager 640 transmits a web browser drive signal to the TV via the second modem (615), and transmits a stored URL to the TV via the second modem (615).

At the point after the second modem transmits a stored URL to the TV, a primary web browser controlling a current Internet screen changes from a web browser of the mobile communication terminal to a web browser of the TV. That is, a change of a control right occurs from the mobile communication terminal to the TV to utilize the browser.

When the URL manager 640 receives an URL from the TV via the second modem (615), the URL manager 640 drives the web browser to access the URL. At this point, a change of a control right occurs from the TV to the mobile communication terminal.

In the above block configuration, the controller 620 may perform some or all the function of the URL manager 640. Separate configuration and illustration of the URL manager 640 of the present invention as shown is provided discussion purposes of each function, but is not a strict requirement.

Therefore, in actual realization of a product, all or some of the functions of the URL manager 640 may be processed by the controller 620.

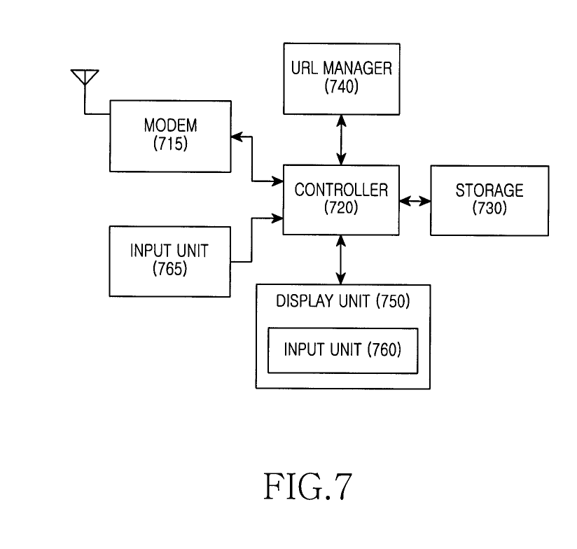

FIG. 7 is a block diagram illustrating a TV according to an exemplary embodiment of the present invention.

Referring now to FIG. 7, the TV includes a modem 715, a controller 720, a storage 730, an URL manager 740, a display unit 750, and input units 760 and 765.

The modem 715 is a module for communicating with other devices, and includes an RF processor and a baseband processor. The RF processor changes a signal received via an antenna into a baseband signal to provide the same to the baseband processor, and changes a baseband signal from the baseband processor to an RF signal so that it may be transmitted on an RF path to transmit the same via the antenna.

A wireless access technology of the modem (715) is not limited. However, the modem (715) is used for short distance wireless communication and will use the Bluetooth for example according to an exemplary embodiment of the present invention.

The controller 720, which may comprise a processor or microprocessor, preferably controls an overall operation of the TV. More particularly, according to an exemplary embodiment of the present invention, the controller 720 controls the URL manager 740.

The storage 730, which is a non-transitory machine readable medium, stores programs for controlling an overall operation of the TV and temporary data occurring during execution of programs.

The display unit 750, which may comprise an LCD or any type of thin film technology screen, displays data output on a screen by the controller 720. In addition, the input units 760 and 765 provide data input by a user to the controller 720.

The input unit 760 is located on the display unit 750 and may be a transparent touch panel. In addition, the input unit 760 includes the above-described Mobile button. The mobile button can be a virtual button activated by touch, or a key, it may also by an icon, or a gesture can also be used to activate the Mobile button (or TV button).

The input unit 765 may comprise a remote controller separately located, and in this case, the Mobile button may exist as a separate button.

When the URL manager 740 receives a TV ALIVE signal from a mobile communication terminal via the modem 715, the URL manager 740 transmits a current on/off state to the mobile communication terminal via the modem 715.

When receiving a TV-on signal via the modem 715, the URL manager 740 turns on the TV so as to be able to display incoming information or images.

When receiving a web browser drive signal from the mobile communication terminal via the modem 715, the URL manager 740 drives a web browser.

When receiving a URL from the mobile communication terminal via the modem 715, the URL manager 740 performs an Internet access using the received URL and a user performs web surfing shown on the display. Control is shifted to the TV from, for example, a mobile terminal that may have sent the URL.

When detecting the user's input of the Mobile button via the input units 760 and 765, the URL manager 740 transmits a current URL of the web browser to the mobile communication terminal via the modem 2 715.

In the above-described block configuration, the controller 720 may perform the function of the URL manager 740. Separate configuration and illustration of the URL manager 740 in an exemplary embodiment of the present invention is for separately describing each function.

Therefore, in actual realization of a product, all or some of the functions of the URL manager 740 may be processed by the controller 720.

According to exemplary embodiments of the present invention, when a user desires to use the Internet via a TV while using the Internet via a mobile communication terminal, the user may continuously use the Internet via shifting image to the TV having a large screen, so that user convenience and consistency in Internet use may be maintained. Control of the web browser can also be shifted to the TV or retained by the mobile communication terminal.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for information transmission between a television (TV) and a mobile communication terminal, the method comprising:
determining, by a mobile communication terminal, whether input of a specific button or gesture is detected during web surfing;
when the input of the specific button or gesture is detected, storing, by the mobile communication terminal, an address in a browser of an Internet site currently being displayed while web surfing; and
transmitting, by the mobile communication terminal, the stored address of the Internet site to the TV.

2. The method of claim 1, further comprising:
displaying, by the TV, the Internet site associated with the address transmitted by the mobile communication terminal.

3. The method of claim 2, wherein the Internet site is displayed by both the mobile communication terminal and the TV.

4. The method of claim 2, further comprising wherein control of a web browser is changed to the TV.

5. The method of claim 1, further comprising:
determining, by the mobile communication, whether or not an address of an Internet site is received from the TV; and
when receiving the address of the Internet site from the TV, accessing by the mobile communication terminal, the address of the Internet site received from the TV.

6. The method of claim 1, further comprising, before the transmitting of the stored address of the Internet site to the TV:
determining, by the mobile communication terminal, an on/off status of the TV;
when the TV is turned off, transmitting, by the mobile communication terminal, a TV-on signal to the TV; and
transmitting, by the mobile communication terminal, a web browser drive signal to the TV.

7. The method of claim 6, wherein the determining of whether the on/off status TV comprises:
transmitting, by the mobile communication terminal, a TV ALIVE signal to the TV;
receiving, by the mobile communication terminal, a response to the TV ALIVE signal from the TV; and
determining, by the mobile communication terminal, whether or not the TV is turned off based on the response signal.

8. The method according to claim 1, wherein the TV comprises a tablet computer.

9. The method of claim 1, further comprising:
performing pairing, by the mobile communication terminal, with the TV before the information exchange when a Bluetooth protocol is used for information exchange with the TV.

10. A method of information transmission between a television (TV) and a mobile communication terminal, the method comprising:
determining, by a TV, whether or not an address of an Internet site currently being displayed by the mobile communication terminal is received from the mobile communication terminal;
when receiving the address of the Internet site from the mobile communication terminal, accessing, by the TV, the received address of the Internet site via a web browser of the TV;
determining. by the TV, whether or not an input of a specific button or specific gesture is detected;
when detecting the input of the specific button or specific gesture, storing. by the TV, an address of an Internet site currently being surfed; and
transmitting, by the TV, the stored address of the Internet site to the mobile communication terminal.

11. The method of claim 10, further comprising:
prior to determining of whether the address of the Internet site is received from the mobile communication terminal:
when receiving a message for determining an on/off status of the TV from the mobile communication terminal, transmitting. by the TV, to the mobile communication terminal a response to the message comprising the on/off status of the TV;
when receiving a TV-on signal from the mobile communication terminal, turning on. by the TV, the TV; and
when receiving a web browser drive signal from the mobile communication terminal, driving, by the TV, the web browser.

12. The method of claim 10, further comprising:
performing pairing, by the TV, with the mobile communication terminal before the information exchange, when a Bluetooth protocol is used for information exchange with the mobile communication terminal.

13. An apparatus of a mobile communication terminal for information transmission between a television (TV) and a mobile communication terminal, the apparatus comprising:
a first modem for communicating with a base station;
a second modem for communicating with the TV; and
a controller for determining whether or not input of a specific button or specific gesture is detected during web surfing via the first modem,
wherein when detecting the input of the specific button or gesture, storing an address of an Internet site currently being accessed under web surfing, and transmitting the stored address of the Internet site to the TV via the second modem for display of the Internet site by the TV so that the display of the Internet site is continuous.

14. The apparatus of claim 13, wherein the controller determines whether or not an address of an Internet site is received from the TV via the second modem, and when receiving the address of the Internet site from the TV, accessing the address of the Internet site received from the TV via the first modem.

15. The apparatus of claim 13, wherein before transmitting the stored address of the Internet site to the TV via the second modem, the controller determines whether or not the TV is turned off via the second modem, and
wherein when the TV is turned off, the controller transmits a TV-on signal to the TV via the second modem, and transmits a web browser drive signal to the TV via the second modem.

16. The apparatus of claim 15, wherein the controller transmits a TV ALIVE signal to the TV via the second modem, receives a response to the TV ALIVE signal, and determines whether or not the TV is turned off based on the response signal or lack thereof.

17. The apparatus of claim 13, wherein when a Bluetooth protocol is used by the second modem for information exchange with the TV, the controller performs pairing with the TV before the information exchange.

18. An apparatus of a television (TV), for information transmission between the TV and a mobile communication terminal, the apparatus comprising:
a modem that communicates with the mobile communication terminal; and
a controller that determines whether or not an address of an Internet site is received from the mobile communication terminal via the modem, when receiving the address of the Internet site from the mobile communication terminal, accessing the address of the Internet site received via the modem, determining whether or not input of a specific button or gesture is detected, when detecting the input of the specific button or gesture, storing an address of an Internet site currently under web surfing, and transmitting the stored address of the Internet site to the mobile communication terminal via the modem.

19. The apparatus of claim 18, wherein prior to determining of whether or not the address of the Internet site is received from the mobile communication terminal via the modem,
the controller transmits a response to the message comprising the on/off state of the TV to the mobile communication terminal when receiving a message for determining an on/off state of the TV from the mobile communication terminal,
when receiving a TV-on signal from the mobile communication terminal, the controller turns on the TV, and
when receiving a web browser drive signal from the mobile communication terminal, the controller drives a web browser.

20. The apparatus of claim 18, wherein when a Bluetooth protocol is used for information exchange with the mobile communication terminal, the controller performs pairing with the mobile communication terminal before the information exchange.
